(19) United States
(12) Patent Application Publication
(10) Pub. No.: US 2006/0072419 A1
(43) Pub. Date: Apr. 6, 2006

(54) Optical scanning device

(75) Inventors: Teunis Willem Tukker, Eindhoven (NL); Bernardus Hendrikus Wilhelmus Hendriks, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/539,900

(22) PCT Filed: Dec. 1, 2003
(86) PCT No.: PCT/IB03/50028

§ 371 Date: Jun. 16, 2005

(30) Foreign Application Priority Data
Dec. 18, 2002 (EP) 02080364.9

(51) Int. Cl. G11B 7/00

(52) U.S. Cl. 369/100; 369/112.01

(57) ABSTRACT

An optical scanning device (1) is for scanning an information layer (2) by means of a radiation beam (4). The device includes a radiation source (7) for supplying said radiation beam, an objective lens (10) for transforming said radiation beam into a scanning spot (19) at the position of the information layer, and a beam intensity modifier (8) for redistributing the intensity (I₂) over the cross-section of said radiation beam in order to change the size of said scanning spot. The beam intensity modifier has an entrance pupil (8a) and an exit pupil (8b). Furthermore, it is arranged so that any ray of said radiation beam entering said beam intensity modifier at a distance r₁ from the central ray of that beam reflects at least twice between said entrance and exit pupils that the transverse magnification M of said modifier is defined by a decreasing function of the distance r₁.

The invention relates to an optical scanning device for scanning an information layer of an optical record carrier by means of a radiation beam of a predetermined wavelength, the device including:

a radiation source for supplying said radiation beam,

an objective lens for transforming said radiation beam into a scanning spot at the position of the information layer, and

a beam intensity modifier having an entrance pupil arranged on the side of said radiation source and an exit pupil arranged on the side of said objective lens, for redistributing the intensity over the cross-section of said radiation beam in order to change the size of said scanning spot.

The invention also relates to a beam intensity modifier for use in such an optical scanning device.

“Scanning an information layer” refers to scanning by means of a radiation beam for reading information in the information layer (“reading mode”), writing information in the information layer (“writing mode”) and/or erasing information in the information layer (“erase mode”).

The “cross-section” of a radiation beam refers to the cross-section of the beam in a plane that is perpendicular to the central ray of the beam.

“Wavefront aberration” refers to the following. An optical element with an optical axis, e.g. a collimator lens, for transforming an object to an image may deteriorate the image by introducing the “wavefront aberration” W_{abb}. Wavefront aberrations have different types expressed in the form of the so-called Zemike polynomials with different orders. Wavefront tilt or distortion is an example of a wavefront aberration of the first order. Astigmatism and curvature of field and defocus are two examples of a wavefront aberration of the second order. Coma is an example of a wavefront aberration of the third order. Spherical aberration is an example of a wavefront aberration of the fourth order. For more information on the mathematical functions representing the aforementioned wavefront aberrations, see, e.g. the book by M. Born and E. Wolf entitled “Principles of Optics,” pp.464-470 (Pergamon Press 6^{th} Ed.) (ISBN 0-08-026482-4). “OPD” of a wavefront aberration W_{abb} refers to the Optical Path Difference of the wavefront aberration. The root-mean-square value OPDᵣₘₛ of the optical path difference OPD is given by the following equation:

$${OPD}_{rms} = \sqrt{\frac{\int \int {g ( r , θ )}^{2} r ⅆ r}{\int \int r ⅆ r ⅆ θ} - {( \frac{\int \int g ( r , θ ) r ⅆ r ⅆ θ}{\int \int r ⅆ r ⅆ θ} )}^{2}}$$

where “g” is the mathematical function which describes the wavefront aberration W_{abb} and “r” and “e” are the polar coordinates of the polar coordinate system (r, θ) in a plane normal to the optical axis, with the origin of the system is the point of intersection of that plane and the optical axis and extending over the entrance pupil of the corresponding optical element.

A commonly encountered concern in the field of optical storage is to increase the information density, i.e. the amount of stored information per unit area of the information layer. The information density depends, inter alia, on the size of the scanning spot formed by the scanning device on the information layer to be scanned. One way to increase the information density is to decrease the size of the scanning spot by increasing the rim intensity of the radiation beam incident to the objective lens.

It is known, e.g. from the article “Flat Intensity Lens with High Optical Efficiency and Small Spot Size for Use in Optical Disc” by Fumihiro Tawa, Shin-ya Hasegawa, Akio Futamata and Takashi Uchiyama, SPIE Vol. 3864, pp.37-. Joint International Symposium on Optical Memory and Optical Data Storage 1999, Koloa, Hawaii, July 1999), an optical scanning device for scanning an information layer of an optical record carrier by means of a radiation beam at a predetermined wavelength. The known optical scanning device includes a radiation source, an objective lens and a beam intensity modifier. The known radiation source supplies the radiation beam. The known objective lens transforms the radiation beam into a scanning spot in the position of the information layer. The known beam intensity modifier redistributes the intensity of the radiation beam in order to change the size of the scanning spot. It has an entrance pupil arranged on the side of the radiation source and an exit pupil arranged on the side of the objective lens.

In the present description a “rim ray” refers to a ray of a radiation beam entering the objective lens at the rim or border of the entrance pupil of that lens. Also, a “rim intensity” refers to a normalized value equals to the intensity of the radiation beam entering the objective lens at the rim or border of the entrance pupil of the objective lens, divided by the maximum of the intensity, i.e. the intensity at the centre of the beam. In the following and by way of illustration only “high rim intensity” refers to a rim intensity equal to or higher than 70% and “low rim intensity” refers to a rim intensity lower than 70%. It is noted that such a rim ray and intensity is defined when the entrance pupil of the objective lens is fully filled, i.e. when the size of the radiation beam entering the objective lens is larger than the radius of the circular entrance pupil of the objective lens.

With reference to the known optical scanning device described above, it is noted that the known beam intensity modifier includes a so-called “flat intensity lens” for redistributing the intensity of the radiation beam. Flat intensity lens are commonly known, e.g. from the article “Lossless Conversion of a Plane Laser Wave to a Plane Wave of Uniform Irradiance”, B. Roy Frieden, Applied Optics vol. 4 pp 1400-1403, 1965. Such a lens redistributes the intensity of a radiation beam, e.g. transforms e.g. a radiation beam entering the lens with an Gaussian-type intensity into a radiation beam emerging from the lens with a flat intensity. Thus, in the optical device known from said article by Fumihiro Tawa et al., the flat intensity lens changes the rim intensity of the radiation beam incident to the objective lens in order to change the size of the scanning spot.

A drawback of the known device provided with such a flat intensity lens is that it is significantly sensitive to a change of the wavelength of the radiation beam. By way of illustration, a conventional diode laser used as the radiation source supplies the radiation beam with a wavelength change of typically 5 nm, e.g. from 405 nm to 410 nm. Table I shows, in case of a wavelength change of 5 nm, the resulting aberrations W_{abb} introduced by the known beam intensity modifier and the values OPDᵣₘₛ of the amounts of those aberrations W_{abb}. The values OPDᵣₘₛ have been calculated from ray-tracing simulations.

TABLE I

| W_{abb} | OPDᵣₘₛ[W_{abb}] |
|---|---|
| W₄₀ | 44 mλ |
| (Third-order spherical aberration) | |
| W₆₀ | 13 mλ |
| (Fifth-order spherical aberration) | |

It is noted that the values OPDᵣₘₛ of the spherical aberration introduced by the known beam intensity modifier due to a wavelength change of 5 nm are relatively high, i.e. equal to or higher than 1 mλ.

Another drawback of the known device is that it is sensitive to misalignment with respect to other optical components of the scanning device, thereby resulting in introducing coma in the radiation beam. For instance, if there is a linear displacement of 5 μm between the radiation source and the known flat intensity lens along the optical axis, the value OPDᵣₘₛ of the introduced amount of coma equals 86 mλ for the third-order and 26 mλ for the fifth-order. Also for instance, if there is a linear displacement of 1 μm between the vertices of the entrance and exit surfaces of the flat intensity lens along the optical axis, the value OPDᵣₘₛ of the introduced amount of coma equals 106 mλ for the third-order and 39 mλ for the fifth-order. Also for instance, if there is an angular displacement of 0.03° between the normals to the entrance and exit surfaces of the flat intensity lens, the value OPDᵣₘₛ of the introduced amount of coma equals 133 mλ for the third-order and 34 mλ for the fifth-order.

An object of the invention is to provide an optical scanning device including a radiation source for supplying a radiation beam, an objective lens for transforming the radiation beam into a scanning spot, and a beam intensity modifier for changing the size of the scanning spot, while the device is less sensitive to wavelength changes than the known scanning device.

This object is achieved by an optical scanning device as described in the opening paragraph wherein, according to the invention, said beam intensity modifier is arranged so that any ray of said radiation beam entering said beam intensity modifier at a distance r₁ from the central ray of said radiation beam reflects at least twice between said entrance and exit pupils such that the transverse magnification M of said intensity modifier is defined by a decreasing function of the distance r₁. In the present description “the transverse magnification M is a decreasing function of the distance r₁” means that the radiation beam entering the beam intensity modifier has a central portion and a marginal portion and that the transverse magnification M for any ray of the central portion is higher than the transverse magnification M for any ray of the marginal portion. Also in the present description, “central and marginal portions” of a radiation beam means two non-overlapping areas of the cross-section of the beam, where any ray of the central portion is at a smaller distance of the central ray of the beam than any ray of the marginal portion. Also, a first value M₁ of the transverse magnification M is “higher” than a second value M₂ of the magnification in the case where

$$\vert \frac{{M}_{1} - {M}_{2}}{{M}_{1}} \vert$$

is higher than preferably 0.1.

Thus, since the radiation beam is reflected through the beam intensity modifier (instead of being refracted as in the known beam intensity modifier), it results that the beam intensity modifier is significantly less sensitive to a wavelength change than the collimator lens in the known device.

According to another aspect of the invention, said beam intensity modifier has an entrance surface and an exit surface that are provided with: a first part and a second part, respectively, that are reflective at said predetermined wavelength; and a third part and a fourth part, respectively, that are refractive at said predetermined wavelength, and wherein said first and third parts are non-overlapping with each other and said second and fourth parts are non-overlapping with each other. It is noted that such a modifier when designed as a lens may be construed as a Schwarzschild lens.

It is noted that the use of Schwarzschild lens as an objective lens in an optical scanning device is known from PH NL010444 and PH NL020076. Each of those known optical scanning devices operates in two modes where the objective lens serves as a catadioptric lens system in the first mode (at a wavelength of 405 nm) and as a refractive lens system at the second mode (at a second wavelength of 660 nm). However, in the known devices, the first and second wavelengths are substantially different from each other, i.e. of more than 10 nm. By contrast, the optical scanning device according to the invention operates in one mode where the wavelength may vary over a range of 5 nm. Furthermore, while PH NL010444 and PH NL020076 teach how to provide the objective lens with a catadioptric arrangement for compensating spherical aberration due to a change in information layer depth when scanning record carriers of different formats, those prior arts do not teach nor suggest how to use a Schwarzschild lens for compensating spherical aberration due to a wavelength change.

The objects, advantages and features of the invention will be apparent from the following, more detailed description of the invention, as illustrated in the accompanying drawings, in which:

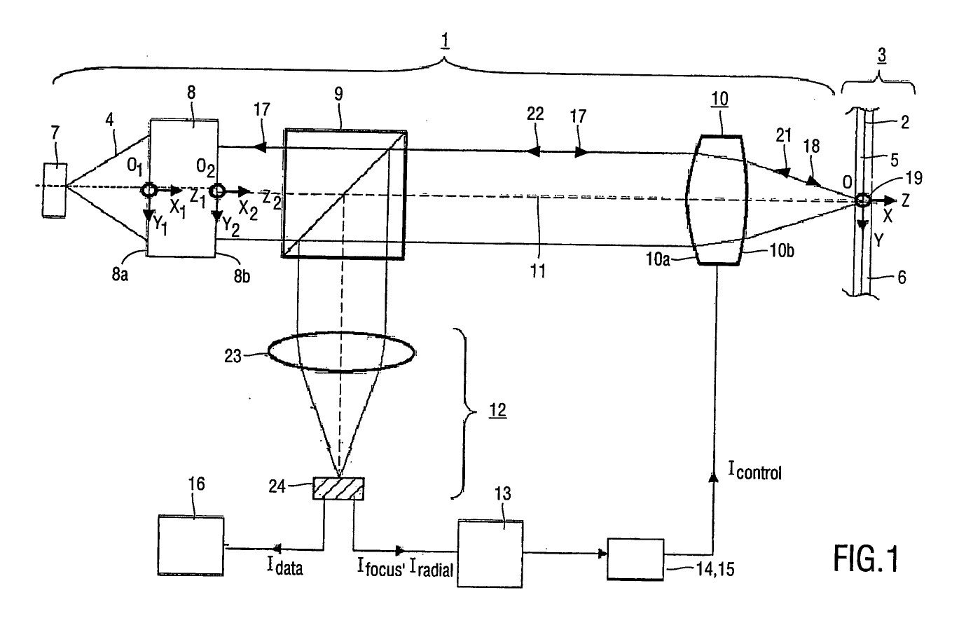

FIG. 1 is a schematic illustration of components of the optical scanning device according to the invention,

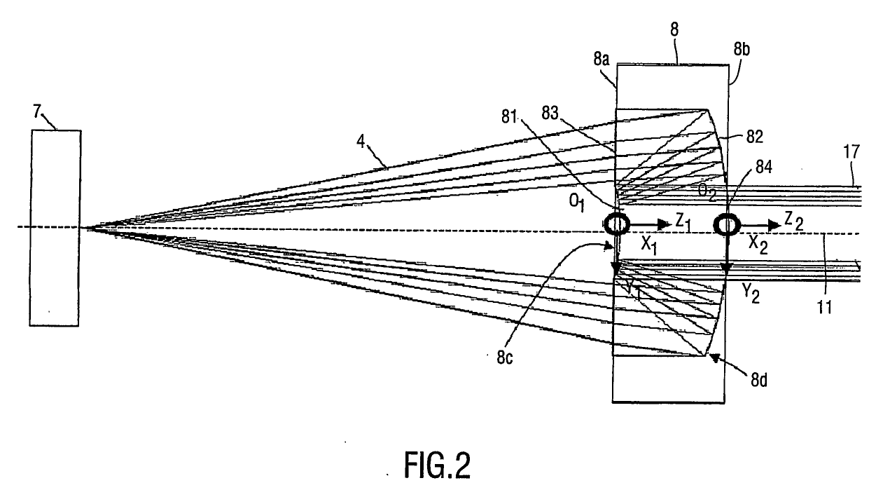

FIG. 2 shows a cross-section of a first embodiment of the beam intensity modifier in FIG. 1,

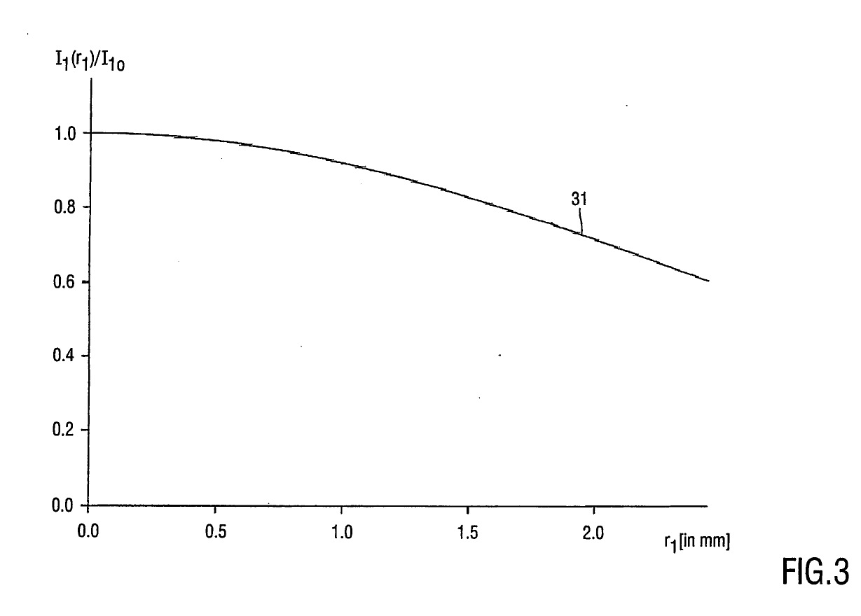

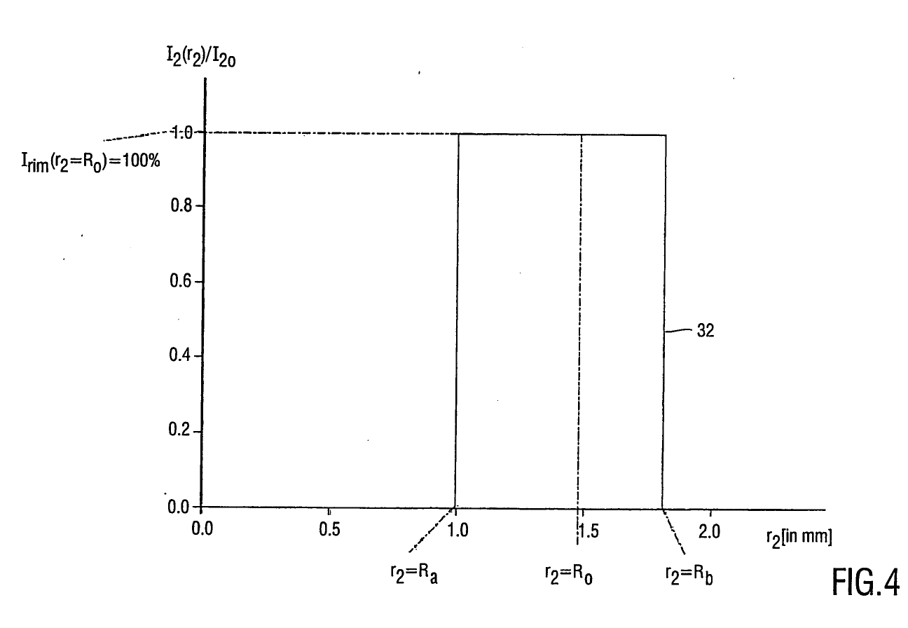

FIGS. 3 and 4 show two respective curves representing the intensities of the radiation beam at the entrance and exit pupils of the beam intensity modifier shown in FIG. 2, respectively,

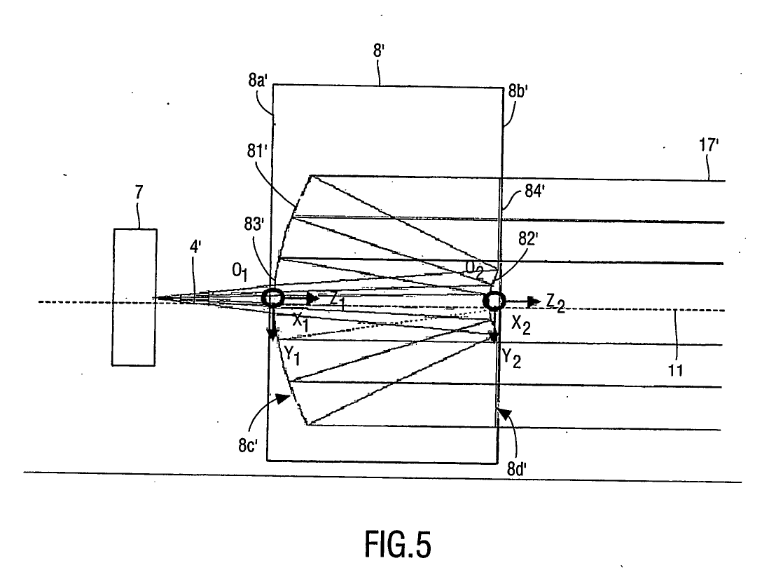

FIG. 5 shows a cross-section of a second embodiment of the beam intensity modifier shown in FIG. 1,

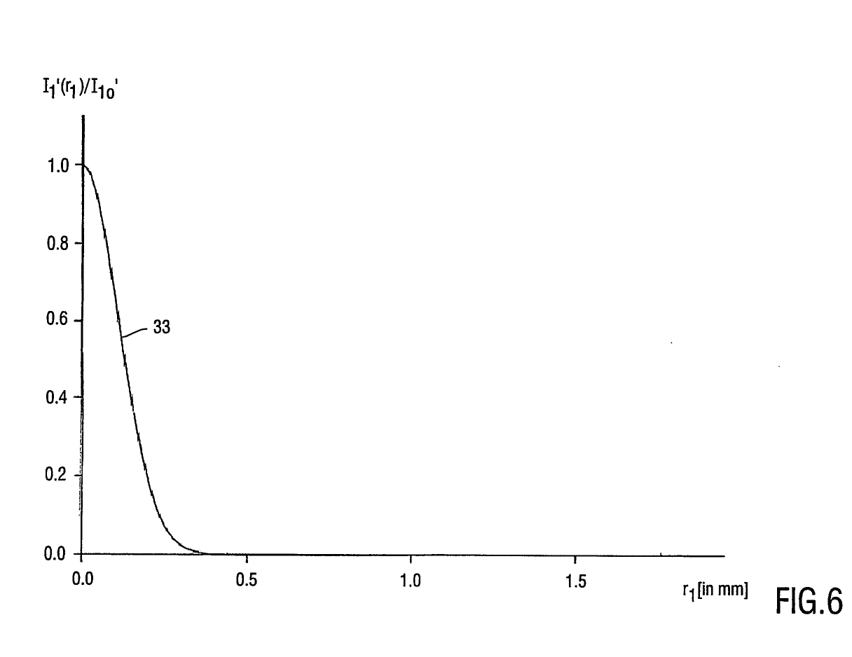

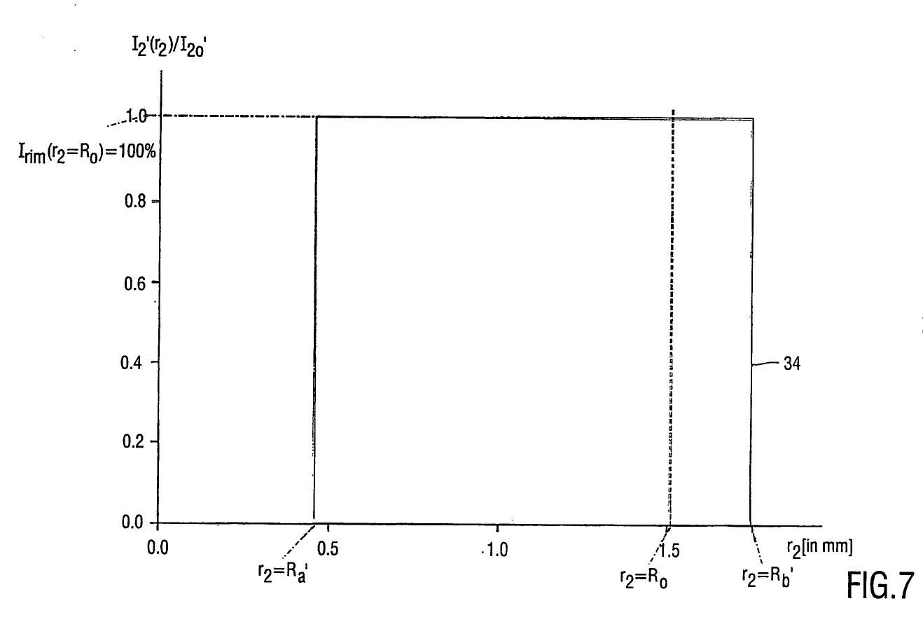

FIGS. 6 and 7 show two respective curves representing the intensities of the radiation beam at the entrance and exit pupils of the beam intensity modifier shown in FIG. 5, respectively, and

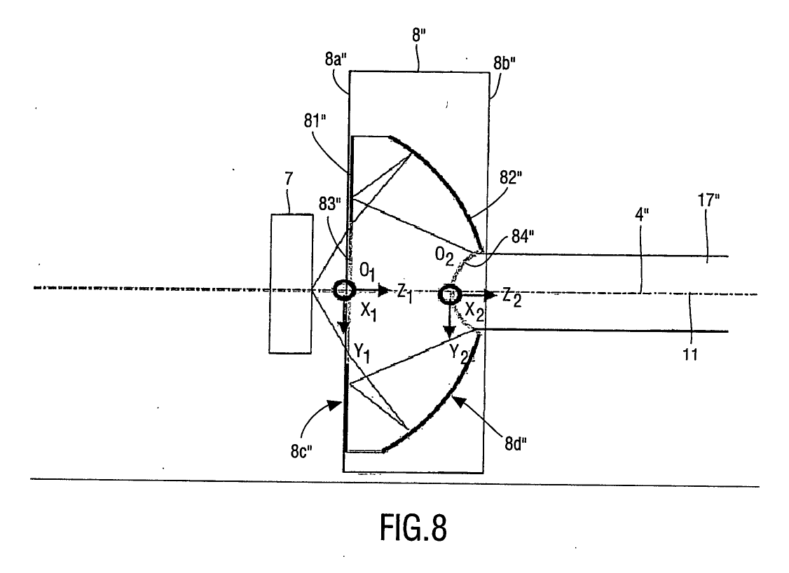

FIG. 8 shows a cross-section of a third embodiment of the beam intensity modifier shown in FIG. 1.

FIG. 1 is a schematic illustration of components of the optical scanning device according to the invention, designated by the numeral reference 1. The optical scanning device 1 is capable of scanning at least one information layer 2 of at least one optical record carrier 3 by means of a radiation beam 4.

By way of illustration, the optical record carrier 3 includes a transparent layer 5 on one side of which the information layer 2 is arranged. The side of the information layer facing away from the transparent layer 5 is protected from environmental influences by a protective layer 6. The transparent layer 5 acts as a substrate for the optical record carrier 3 by providing mechanical support for the information layer 2. Alternatively, the transparent layer 5 may have the sole function of protecting the information layer 2, while the mechanical support is provided by a layer on the other side of the information layer 2, for instance by the protective layer 6 or by an additional information layer and transparent layer connected to the uppermost information layer. It is noted that the information layer has an information layer depth that corresponds to the thickness of the transparent layer 5. The information layer 2 is a surface of the carrier 3. That surface contains at least one track, i.e. a path to be followed by the spot of a focused radiation on which path optically-readable marks are arranged to represent information. The marks may be, e.g., in the form of pits or areas with a reflection coefficient or a direction of magnetization different from the surroundings.

The optical scanning device 1 includes a radiation source 7, a beam splitter 9, an objective lens 10 having an optical axis 11, and a detection system 12. Also, it includes a beam intensity modifier that is arranged, in that embodiment, for serving as a collimator lens. In the following the beam intensity modifier and the collimator lens are designated in the following with the same reference numeral 8. Alternatively, the beam intensity modifier and the collimator lens may be formed as two separate elements. Furthermore, the optical scanning device 1 includes a servocircuit 13, a focus actuator 14, a radial actuator 15, and an information processing unit 16 for error correction.

In the following “Z-axis” corresponds to the optical axis 11 of the objective lens 10. “O” is the point of intersection between the optical axis 11 and the information plane 2. In the case where the optical record carrier 3 has the shape of a disc, the following is defined with respect to a given track: the “radial direction” is the direction of a reference axis, the X-axis, between the track and the center of the disc and the “tangential direction” is the direction of another axis, the Y-axis, that is tangential to the track and perpendicular to the X-axis. It is noted that (O, X, Y, Z) forms an orthogonal base associated with the position of the information plane 2.

The radiation source 7 supplies the radiation beam 4 at a desired wavelength λ. For example, the radiation source 7 comprises a semiconductor laser-for supplying the radiation beam 4. It is noted that the actual wavelength of the radiation beam 4 provided with by the radiation source 7 is variable between λ−Δλ and λ+Δλ. Typically, the variation 2Δλ equals 5 nm. In the following and by way of illustration only the radiation beam 4 emitted from the radiation source 7 has a circular cross-section. Alternatively, the radiation beam 4 has an elliptical cross-section.

The collimator lens 8 is arranged along the optical path of the radiation beam 4 and, in that embodiment, between the radiation source 7 and the beam splitter 9. The collimator lens 8 transforms the radiation beam 4 into a substantially collimated beam 17. The collimator lens 8 has an optical axis that is the same as the optical axis 11 of the objective lens 10.

The beam splitter 9 is arranged, in that embodiment, between the collimator lens 8 and the objective lens 10. The beam splitter 9 transmits the collimated radiation beam 17 toward the objective lens 10.

The objective lens 10 transforms the radiation beam 25 to a focused radiation beam 18 so as to form a scanning spot 19 in the position of the information layer 2. In the embodiment shown in FIG. 1 the objective lens 10 has an entrance pupil 10a and an exit pupil 10b that are rotational symmetric with respect to the optical axis 11: the entrance pupil 10a has a circular rim or border. In the following “Rₒ” is the radius (positive value) of the entrance pupil 10a and by way of illustration only Rₒ is equal to 1.5 mm. It is noted that the objective lens may be formed as a hybrid lens such as a lens combining refractive elements, used in an infinite-conjugate mode. Such a hybrid lens may be formed by means of either a diamond turning process or a lithographic process using the photopolymerization of, e.g., an UV curing lacquer. It is also noted that the objective lens 10 shown in FIG. 1 is formed as a convex-convex lens; however, other lens element types such as plano-convex or convex-concave lenses can be used. Alternatively, the optical scanning device may include one or more pre-objective lenses arranged between the collimator lens and the objective lens so as to form a compound objective lens system.

The beam intensity modifier 8 is arranged for redistributing the intensity of the radiation beam 17 in order to change the size of the scanning spot 19. The beam intensity modifier 8 has an entrance pupil arranged on the side of the radiation source 7 and an exit pupil arranged on the side of the objective lens 10. In the embodiment shown in FIG. 1 “O₁” is the point of intersection between the optical axis 11 and the entrance pupil 8a, “X₁-axis” and “Y₁-axis” are two axes of the entrance pupil 8a that are orthogonal to each other, and “Z₁-axis” is the axis normal to the entrance pupil 8a and passing through the point O₁. It is noted that (O₁, X₁, Y₁, Z₁) forms an orthogonal base associated with the position of the entrance pupil 8a. It is also noted in the embodiment shown in FIG. 1 that the entrance pupil 8a is centered on the optical axis 11 of the objective lens 10: the X₁-, Y₁- and Z₁-axes are therefore parallel to the X-, Y- and Z-axes, respectively. Likewise, “O₂” is the point of intersection between the optical axis 11 and the exit pupil 8b, “X₂-axis” and “Y₂-axis” are two axes of the exit pupil 8b that are orthogonal to each other, and “Z₂-axis” is the axis normal to the exit pupil 8b and passing through the point O₂. It is noted that (O₂, X₂, Y₂, Z₂) forms an orthogonal base associated with the position of the exit pupil 8b. It is also noted in the embodiment shown in FIG. 1 that the exit pupil 8b is centered on the optical axis 11 of the objective lens 10: the X₂-, Y₂- and Z₂-axes are therefore parallel to the X-, Y- and Z-axes, respectively.

Furthermore, the beam intensity modifier 8 is arranged so that any ray of said radiation beam entering said beam intensity modifier at a distance r₁ from the central ray of the radiation beam 4 reflects at least twice between the entrance and exit pupils 8a and 8b of the beam intensity modifier 8 such that the transverse magnification M of the intensity modifier is a decreasing function of the distance r₁. It is noted in that embodiment that the radiation beam 4 has a circular cross-section and that the distance r₁ equals the distance between that ray and the optical axis 11 in the entrance pupil 8a; in other words, r₁ is the first polar coordinate associated with the Cartesian coordinate system (O₁, X₁, Y₁).

It has been known from said article by B. Roy Frieden that, in the case where the radiation beam 4 provided by the radiation source 7 is a Gaussian-type beam and in the paraxial approximation, the transverse magnification M for a ray of the radiation beam 4 entering the beam intensity modifier 8 at a distance r₁ in the entrance pupil 8a is given by the following equation:

$$M = \frac{{R}_{exit}}{{r}_{1}} \sqrt{\frac{1 - {ⅇ}^{- {( \frac{{r}_{1}}{α} )}^{2} 4 ln 2}}{1 - {ⅇ}^{- {( \frac{{R}_{entrance}}{α} )}^{2} 4 ln 2}}} \qquad ( 1 )$$

where “R_{entrance}” is the radius of the entrance pupil 8a of the beam intensity modifier 8, “Rₑₓᵢₜ” is the radius of the exit pupil 8b of the beam intensity modifier 8, and “α” ▪ parameter dependent on inter alia the radiation source 7 (in the case where the radiation beam 4 is a Gaussian-type beam, the parameter a is the so-called Full Width Half Maximum (F.W.H.M.). In the following and by way of illustration only the parameter α equals 5.73 mm (in the case where the radiation beam 4 has a circular cross-section). Alternatively, in the case where the radiation beam 4 has an elliptical cross-section, the parameter a has two different values in respect of the short and long axes of that cross-section, respectively. The beam intensity modifier 8 is described further in detail.

During scanning the record carrier 3 rotates on a spindle (not shown in FIG. 1) and the information layer 2 is then scanned through the transparent layer 5. The focused radiation beam 18 reflects on the information layer 2, thereby forming a reflected beam 21 which returns on the optical path of the forward converging beam 18. The objective lens 10 transforms the reflected radiation beam 21 to a reflected substantially collimated radiation beam 22. The beam splitter 9 separates the forward radiation beam 17 from the reflected radiation beam 22 by transmitting at least a part of the reflected radiation beam 22 towards the detection system 12.

The detection system 12 includes a convergent lens 23 and a quadrant detector 24 for capturing said part of the reflected radiation beam 22. The quadrant detector 24 converts the part of the reflected radiation beam 22 to one or more electrical signals. One of the signals is an information signal I_{data}, the value of which represents the information scanned on the information layer 2. The information signal data I_{data} is processed by the information processing unit 16 for error correction. Other signals from the detection system 12 are a focus error signal I_{focus} and a radial tracking error signal I_{radial}. The signal I_{focus} represents the axial difference in height along the Z-axis between the scanning spot 19 and the position of the information layer 2. Preferably, the signal I_{focus} is formed by the “astigmatic method” which is known from, inter alia, the book by G. Bouwhuis, J. Braat, A. Huijser et al, entitled “Principles of Optical Disc Systems,” pp. 75-80 (Adam Hilger 1985) (ISBN 0-85274-785-3). The radial tracking error signal I_{radial} represents the distance in the XY-plane of the information layer 2 between the scanning spot 19 and the center of a track in the information layer 2 to be followed by the scanning spot 19. Preferably, the signal I_{radical} is formed from the “radial push-pull method” which is known from, inter alia, the book by G. Bouwhuis, pp. 70-73.

The servocircuit 13 is arranged for, in response to the signals I_{focus} and I_{radial}, providing servo control signals I_{control} for controlling the focus actuator 14 and the radial actuator 15, respectively. The focus actuator 14 controls the position of the objective lens 10 along the Z-axis, thereby controlling the position of the scanning spot 19 such that it coincides substantially with the plane of the information layer 2. The radial actuator 14 controls the position of the objective lens 10 along the X-axis, thereby controlling the radial position of the scanning spot 19 such that it coincides substantially with the center line of the track to be followed in the information layer 2.

The beam intensity modifier 8 is now described in further detail. As already mentioned, the modifier is arranged for modifying the light power of the scanning spot 19 so that the spot has a desired size. Thus, the beam intensity modifier 8 transforms the radiation beam 4 entering the entrance plane 8a has an intensity I₁ in the cross-section of that radiation beam into the radiation beam 17 emerging from the exit plane 8b with an intensity I₂ in the cross-section of that radiation beam.

FIG. 2 shows a cross-section of a first embodiment of the beam intensity modifier (and collimator lens) 8 shown in FIG. 1. As shown in FIG. 2, the beam intensity modifier 8 has an entrance surface 8a and an exit surface 8b. In that embodiment, the entrance surface 8c is provided with a first part 81 and the exit surface 8d is provided with a second part 82. The first and second parts 81 and 82 are reflective at said predetermined wavelength (of the radiation beam 4). In the embodiment shown in FIG. 2 the first part 81 is a central part with respect to an optical axis of the beam intensity modifier 8, i.e. in that embodiment the optical axis 11, and the second part 82 is a marginal part with respect to that optical axis. It is noted that that arrangement of the parts 81 and 82 decreases the size of the cross-section of the radiation beam 17. In the present description a “central part” with respect to an optical axis means an area centered on the optical axis. A “marginal part” means an annular area around a central part.

Furthermore, the entrance surface 8c is provided with a third part 83 and the exit surface 8d is provided with a fourth part 84. The third and fourth parts 83 and 84 are refractive at said predetermined wavelength (of the radiation beam 4). In the embodiment shown in FIG. 2 the third part 83 is a marginal part with respect to an optical axis of the beam intensity modifier 8, i.e. in that embodiment the optical axis 11, and the fourth part 84 is a central part with respect to that optical axis. Also, the first and third parts 81 and 83 are non-overlapping with each other and the second and fourth parts 82 and 84 are non-overlapping with each other. Thus, the cross-section of the radiation beam 4 in the entrance pupil 8a has one area that is affected by the optical properties of the part 83 (i.e. transmission) and another area that does not overlap the other area and that is affected by the optical properties of the part 81 (i.e. reflection). Similarly, the cross-section of the radiation beam 17 in the exit pupil 8b has one area that is affected by the optical properties of the part 84 (i.e. transmission) and another area that does not overlap the other area and that is affected by the optical properties of the part 82 (i.e. reflection).

FIG. 3 shows a curve 31 representing the intensity I₁ at the entrance pupil 8a of the beam intensity modifier shown in FIG. 2. As shown in FIG. 3, the intensity I₁ has a Gaussian-like profile:

$${I}_{1} ( {r}_{1} ) = {I}_{1 o} {ⅇ}^{- {( \frac{{r}_{1}}{α} )}^{2} 4 ln 2} \qquad ( 2 )$$

where “I₁(r₁)” is the value of the intensity I₁ at a point of polar coordinates (r₁, θ₁) in the Cartesian coordinate system (O₁, X₁, Y₁), “I₁ₒ” is the maximum of the intensity I₁ (i.e. the intensity of the central ray of the radiation beam 4).

FIG. 4 shows a curve 32 representing the intensity I₂ at the exit pupil 8b of the beam intensity modifier 8 shown in FIG. 2. As shown in FIG. 3, in that embodiment, the intensity I₂ is flat:
I₂(r₂)=I₂ₒ for Rₐ<|r₂|<R_{b}
0 for 0≦|r₂|≦Rₐ and R_{b}<|r₂| (3)
where “I₂(r₂)” is the value of the intensity I₂ at a point of polar coordinates (r₂, θ₂) in the Cartesian coordinate system (O₂, X₂, Y₂), “I₂ₒ” is the maximum of the intensity I₂ (i.e. the intensity of any annular ray of the radiation beam 17) and “Rₐ” and “R_{b}” are two constant parameters that depend on design parameters of the beam intensity modifier 8. In the present description an “annular ray” is a ray intersecting the cross-section of the radiation beam 17 in the exit pupil of the beam intensity modifier 8 at the distance r₂ from the optical axis 11, that is comprised between Rₐ and R_{b}. In the following and by way of illustration only the parameter Rₐ and R_{b} equal 1.00 and 1.75 mm, respectively. It is noted that in the case where the radiation beam 4 has an elliptical cross-section each of the parameters Rₐ and R_{b} may have two different values in respect of the short and long axes of that cross-section, respectively. It is noted in that embodiment that the rim intensity of the radiation beam 17 equals 100%.

The design of the beam intensity modifier 8 is now described in detail.

Firstly, knowing the function representing the transverse magnification M of the beam modifier (i.e. Equation (1)), the functions representing the positions along the optical axis 11 of the entrance and exit surfaces 8c and 8d of the beam intensity modifier 8 can be determined. This is further in the article “Aplanatic optical system containing two aspheric surfaces”, J. J. M. Braat and P. F. Greve, Applied Optics vol. 18, No. 13 p. 2187 et seq., 1979. Thus, for each of the rotational symmetric aspherical shape of the entrance and exit surfaces 8c and 8d the curved area is given by the following equation:

$$H ( r ) = {\sum }_{i = 1}^{15} {B}_{2 i} {r}^{2 i}$$

where “H(r)” is the position of the surface along the optical axis 11 in millimeters, “r” is the distance to the optical axis 11 in millimeters, and “Bₖ” is the coefficient of the k-th power of H(r). For the entrance surface 8c, the values of the coefficients B₂, B₄, B₆, B₈, B₁₀, B₁₂, B₁₄, B₁₆, B₁₈, B₂₀, B₂₂, B₂₄, B₂₆, B₂₈ and B₃₀ are 0.057391202, 0.0035993029, 0.000323862 3.797974e-005, 1.4115487e-005, −1.6826926e-005, 2.6819208e-005, −2.815484e-005, 2.1416509e-005, −1.1731386e-005, 4.6012333e-006, −1.2604342e-006, 2.2942757e-007, −2.4974661e-008, and 1.2359497e-009, respectively. For the exit surface 8d, the values of the coefficients B₂, B₄, B₆, B₈, B₁₀, B₁₂, B₁₄, B₁₆, B₁₈, B₂₀, B₂₂, B₂₄, B₂₆, B₂₈ and B₃₀ are 0.036587557, 0.00028055283, −1.1993417e-006, 1.0252619e-008, −7.0401158e-011, 7.0719251e-013, −6.1560444e-015, 4.646542e-017, −2.2015109e-019, 0, 0, 0, 0, 0, and 0, respectively. The beam modifier 8 has a thickness of 4.00 mm along the Z-axis (direction of its optical axis) and the entrance pupil 8a with a diameter of 8.16 mm. The numerical aperture of the beam modifier 8 is equal to 0.2 at a wavelength of 405 nm. The body of the beam modifier 8 is made of COC with a refractive index equal to 1.55 at a wavelength of 405 nm.

Secondly, it is noted in that embodiment that the radiation beam 4 enters the beam modifier 8 via the third refractive marginal part 83. In that embodiment the part 83 is planar and has a cross-section in the entrance pupil 8a with a first (central) radius and a second (marginal) radius equal to the radius of the entrance surface 8c. In the following and by way of illustration only those first and second radii of the part 83 equal 1.75 mm and 4.08 mm, respectively. The cross-section of the first reflective part 81 in the entrance pupil 8a has a radius equal to the first (central) radius of the part 83. The cross-section of the second central reflective part 82 in the exit pupil 8b has a first (central) radius and a second (marginal) radius equal to the radius of the exit surface 8d. In the following and by way of illustration only those first and second radii of the part 82 equal 1.75 mm and 4.53 mm, respectively. The cross-section of the fourth refractive part 84 has a radius equal to said first (central) radius of the cross-section of the part 82. It is noted that the radii of the entrance and exit surfaces 8c and 8d depend on the distance between the two vertices of those surfaces (which is equal in that embodiment to 4.00 mm).

Table II shows, in case of a change of the wavelength of the radiation beam equals to 5 nm and the values OPDᵣₘₛ of the resulting aberrations W_{abb} introduced by the beam intensity modifier 8 shown in FIG. 2 and designed as described above. The values OPDᵣₘₛ have been calculated from ray-tracing simulations.

TABLE II

| W_{abb} | OPDᵣₘₛ[W_{abb}] |
|---|---|
| W₄₀ | 0.6 mλ |
| (Third-order spherical aberration) | |
| W₆₀ | 0.08 mλ |
| (Fifth-order spherical aberration) | |

By comparison between Tables I and II, it is noted that the values OPDᵣₘₛ of the spherical aberration introduced by the beam intensity modifier 8 due to a wavelength change of 5 nm are significantly smaller than the values OPDᵣₘₛ of the spherical aberration introduced by the known beam intensity modifier due to a wavelength change of 5 nm. Thus, an advantage of providing such first and second optical parts is that a small variation of the wavelength, e.g. from 405 nm to 410 nm, results in the generation of spherical aberration that equals to 0.6 mλ for the third order, 0.08 mλ for the fifth order. Consequently, the optical scanning device 1 allows scanning of the optical record carrier 3 while being less sensitive to wavelength changes than the known scanning device.

An alternative of the first embodiment shown in FIG. 2 is now described. FIG. 5 shows a cross-section of a second embodiment of the beam intensity modifier (and collimator lens) shown in FIG. 1, designated in the following with the reference numeral 8′. Similarly to the first embodiment, the beam intensity modifier 8′ has an entrance pupil 8a′ and an exit pupil 8b′; it transforms the radiation beam 4 entering the entrance pupil 8a′ with an intensity I₁′ in the cross-section of that radiation beam into the radiation beam 17 emerging from the exit plane 8b′ with an intensity I₂′ in the cross-section of that radiation beam.

As shown in FIG. 5, the beam intensity modifier 8′ has an entrance surface 8c′ and an exit surface 8d′. Similarly to the first embodiment, the entrance surface 8c′ is provided with a first part 81′ and the exit surface 8d′ is provided with a second part 82′ and the first and second parts 81′ and 82′ are reflective at said predetermined wavelength (of the radiation beam 4). In the embodiment shown in FIG. 5 the first part 81′ is a marginal part with respect to an optical axis of the beam intensity modifier 8′, i.e. in that embodiment the optical axis 11, and the second part 82′ is a central part with respect to that optical axis. It is noted that that arrangement of the parts 81′ and 82′ increases the size of the cross-section of the radiation beam 17.

Furthermore, similarly to the first embodiment, the entrance surface 8c′ is provided with a third part 83′ and the exit surface 8d′ is provided with a fourth part 84′ and the third and fourth parts 83′ and 84′ are refractive at said predetermined wavelength (of the radiation beam 4). In the embodiment shown in FIG. 5 the third part 83′ is a central part with respect to an optical axis of the beam intensity modifier 8′, i.e. in that embodiment the optical axis 11, and the fourth part 84′ is a marginal part with respect to that optical axis. Also, the first and third parts 81′ and 83′ are non-overlapping with each other and the second and fourth parts 82′ and 84′ are non-overlapping with each other.

FIG. 6 shows a curve 33 representing the intensity I₁′ at the entrance pupil 8a of the beam intensity modifier 8′ shown in FIG. 5. As shown in FIG. 6, the intensity I₁′ has a Gaussian-like profile:

$${I}_{1}^{′} ( {r}_{1} ) = {I}_{1 o}^{′} {ⅇ}^{- {( \frac{{r}_{1}}{{α}^{′}} )}^{2} 4 ln 2} \qquad ( 7 )$$

where “I₁′(r₁)” is the value of the intensity I₁′ at a point of polar coordinates (r₁, θ₁) in the Cartesian coordinate system (O₁, X₁, Y₁), “I₁ₒ′” is the maximum of the intensity I₁′ (i.e. the intensity of the central ray of the radiation beam 4) and “α′” is a constant parameter that depends inter alia on the radiation source 7. In the following and by way of illustration only the radiation beam 4 emitted from the radiation source 7 has a circular cross-section. For example only, the parameter α′ equals 0.257 mm. Alternatively, the radiation beam 4 may have an elliptical cross-section and the parameter α′ has therefore two different values in respect of the short and long axes of that cross-section, respectively.

FIG. 7 shows a curve 34 representing the intensity I₂′ at the exit pupil 8b′ of the beam intensity modifier 8′ shown in FIG. 5. As shown in FIG. 7, in that embodiment, the intensity I₂′ is flat:
I₂′(r₂)=I₂ₒ′ for Rₐ′<|r₂|<R_{b}′
0 for 0≦|r₂|≦Rₐ′ and R_{b}′<|r₂| (8)
where “I₂′(r₂)” is the value of the intensity I₂′ at a point of polar coordinates (r₂, θ₂) in the Cartesian coordinate system (O₂, X₂, Y₂), “I₂ₒ′” is the maximum of the intensity I₂′ (i.e. the intensity of any annular ray of the radiation beam 17) and “Rₐ′” and “R_{b}′” are two constant parameters that depend on design parameters of the beam intensity modifier 8′. In the following and by way of illustration only the parameter Rₐ′ and R_{b}′ equal 0.46 and 1.75 mm, respectively. It is noted that in the case where the radiation beam 4 has an elliptical cross-section each of the parameters Rₐ′ and R_{b}′ may have two different values in respect of the short and long axes of that cross-section, respectively.

The second embodiment of the beam intensity modifier, 8′, is designed in a manner similar to the first embodiment as described above. Thus, for each of the rotational symmetric aspherical shape of the entrance and exit surfaces 8c′ and 8d′ the curved area is given by the following equation:

$$H ( r ) = {\sum }_{i = 1}^{15} {B}_{2 i} {r}^{2 i}$$

where “H(r)” is the position of the surface along the optical axis 11 in millimeters, “r” is the distance to the optical axis 11 in millimeters, and “Bₖ” is the coefficient of the k-th power of H(r). For the entrance surface 8c′, the values of the coefficients B₂, B₄, B₆, B₈, B₁₀, B₁₂, B₁₄, B₁₆, B₁₈, B₂₀, B₂₂, B₂₄, B₂₆, B₂₈ and B₃₀ are −0.10563042, 0.00075405216, 6.9109148e-005, 8.1029703e-006, 3.3510049e-006, 4.−267808e-006, 6.7411641e-006, −7.0777688e-006, 5.3786095e-006, −2.9438623e-006, 1.1535577e-006, −3.1568701e-007, 5.7397869e-008, −6.2401306e-009, and 3.0830821e-010, respectively. For the exit surface 8d′, the values of the coefficients B₂, B₄, B₆, B₁₀, B₁₂, B₁₄, B₁₆, B₁₈, B₂₀, B₂₂, B₂₄, B₂₆, B₂₈ and B₃₀ are −0.48671506, 0.66841815, −0.90723145, 1.3257115, −2.1018858, 3.5430975, −5.9788675, 9.0431458, −10.160921, 5.9287541, 0, 0, 0, 0, and 0, respectively. The beam modifier 8′ has a thickness of 2.00 mm along the Z-axis (direction of its optical axis) and the entrance pupil 8a′ with a diameter of 3.5 mm. The numerical aperture of the beam modifier 8′ is equal to 0.2 at a wavelength of 405 nm. The body of the beam modifier 8′ is made of COC with a refractive index equal to 1.55 at a wavelength of 405 nm.

Secondly, it is noted in that embodiment that the radiation beam 4′ enters the beam modifier 8′ via the third refractive central part 83′. In that embodiment the part 83′ is planar and has a cross-section in the entrance pupil 8a′ with a radius equal to NA.f.f1., where “NA” is the numerical aperture of the radiation beam 4′ and “f.f.1.” is the front focal length of the beam intensity modifier 8′. In the following and by way of illustration only, that radius of the part 83′ equals 0.20 mm. The cross-section of the first reflective part 81′ in the entrance pupil 8a′ has a first (central) radius equal to the radius of the part 83′ and a second (marginal) radius equal to the radius of the entrance surface 8c′. In that embodiment those first and second radii equal 0.20 and 1.75 mm, respectively. The cross-section of the fourth marginal refractive part 84′ in the exit pupil 8b′ has a first (central) radius and a second (marginal) radius equal to the radius of the exit surface 8d′. In that embodiment those first and second radii equal 0.46 and 1.75 nm, respectively. The cross-section of the second (central) reflective part 82′ has a radius equal to said first (central) radius of the part 84′. It is noted that the radii of the entrance and exit surfaces 8c′ and 8d′ depend on the distance between the two vertices of those surfaces.

Table III shows, in case of a change of the wavelength of the radiation beam equals to 5 nm and the values OPDᵣₘₛ of the resulting aberrations W_{abb} introduced by the beam intensity modifier 8′ shown in FIG. 5 and designed as described above. The values OPDᵣₘₛ have been calculated from ray-tracing simulations.

TABLE III

| W_{abb} | OPDᵣₘₛ[W_{abb}] |
|---|---|
| W₄₀ | 0.02 mλ |
| (Third-order spherical aberration) | |
| W₆₀ | 0.01 mλ |
| (Fifth-order spherical aberration) | |

By comparison between Tables I and III, it is noted that the values OPDᵣₘₛ of the spherical aberration introduced by the beam intensity modifier 8′ due to a wavelength change of 5 nm are significantly smaller than the values OPDᵣₘₛ of the spherical aberration introduced by the known beam intensity modifier due to a wavelength change of 5 nm. Thus, an advantage of providing such first and second optical structures is that a small variation of the wavelength, e.g. from 405 nm to 410 nm, results in the generation of spherical aberration equals to 0.02 mλ for the third order and 0.01 mλ for the fifth order. Consequently, the optical scanning device 1 allows scanning of the optical record carrier 3 while being less sensitive to wavelength changes than the known scanning device.

Another advantage of the beam intensity modifier 8′ is that it is substantially free of defocus. Indeed, the collimator lens in that embodiment generates an amount of defocus with a value OPDᵣₘₛ equal to 4.56 mλ by comparison, the known flat intensity lens generates an amount of defocus with a value OPDᵣₘₛ equal to 99 mλ. Also, it is noted that the beam intensity modifier 8′ shown in FIG. 5 advantageously introduces less defocus than the beam intensity modifier 8 shown in FIG. 2.

It is to be appreciated that numerous variations and modifications may be employed in relation to the embodiments described above, without departing from the scope of the invention that is defined in the appended claims.

As a further alternative to the first and second embodiments of the beam intensity modifier shown in FIGS. 2 and 5, both reflective parts are marginal parts. Thus, FIG. 8 shows a cross-section of a third embodiment 8″ of the beam intensity modifier shown in FIG. 1. As shown in FIG. 8, the beam intensity modifier 8″ has an entrance surface 8c″ and an exit surface 8b″. Similarly to the first embodiment, the entrance surface 8c″ is provided with a first part 81″ and the exit surface 8d″ is provided with a second part 82″ and the first and second parts 81″ and 82″ are reflective at said predetermined wavelength (of the radiation beam 4″). In the embodiment shown in FIG. 8 the first and second parts 81″ and 82″ are marginal parts with respect to an optical axis of the beam intensity modifier 8″, i.e. in that embodiment the optical axis 11. Furthermore, similarly to the first embodiment, the entrance surface 8c″ is provided with a third part 83″ and the exit surface 8d″ is provided with a fourth part 84″ and the third and fourth parts 83″ and 84″ are refractive at said predetermined wavelength (of the radiation beam 4″). In the embodiment shown in FIG. 8 the third and fourth parts 83″ and 84″ are central parts with respect to the optical axis 11. Also, the first and third parts 81″ and 83″ are non-overlapping with each other and the second and fourth parts 82″ and 84″ are non-overlapping with each other.

As an alternative of the beam intensity modifier as described above, the intensity of the cross-section of the radiation emerging from the modifier may have an intensity profile other than flat, as described in the article “Objective lenses for DVD & Near-Field Optical Disk Pick-up” by C. W. Lee and D. H. Shin, pp. 59 et seq. (part of ODF, Tokyo, Japan, 1998).

As an alternative of the beam intensity modifier described above, the radiation beam is a Lorentzian-type beam instead of a Gaussian-type beam.

1. An optical scanning device for scanning an information layer of an optical record carrier by means of a radiation beam of a predetermined wavelength, the device including:
a radiation source for supplying said radiation beam,
an objective lens for transforming said radiation beam into a scanning spot at the position of the information layer, and
a beam intensity modifier having an entrance pupil arranged on the side of said radiation source and an exit pupil arranged on the side of said objective lens, for redistributing the intensity over the cross-section of said radiation beam in order to change the size of said scanning spot,
characterized in that said beam intensity modifier is arranged so that any ray of said radiation beam entering said beam intensity modifier at a distance r₁ from the central ray of said radiation beam reflects at least twice between said entrance and exit pupils such that the transverse magnification M of said intensity modifier is defined by a decreasing function of the distance r₁.

2. An optical scanning device according to claim 1, wherein said beam intensity modifier has an entrance surface and an exit surface that are provided with a first part and a second part, respectively, that are reflective at said predetermined wavelength.

3. An optical scanning device as claimed in claim 2, characterized in that said first part is a central part and said second part is a marginal part, with respect to an optical axis of said beam intensity modifier.

4. An optical scanning device as claimed in claim 2, characterized in that said first part is a marginal part and said second part is a central part, with respect to an optical axis of said beam intensity modifier.

5. An optical scanning device as claimed in claim 2, characterized in that said first and second parts are marginal parts with respect to an optical axis of said beam intensity modifier.

6. An optical scanning device according to claim 2, wherein said entrance and exit surfaces are further provided with a third part and a fourth part, respectively, that are refractive at said predetermined wavelength, and wherein said first and third parts are non-overlapping with each other and said second and fourth parts are non-overlapping with each other.

7. An optical scanning device according to claim 1, wherein said beam intensity modifier is further arranged for serving as a collimator lens or as said objective lens.

8. An optical scanning device according to claim 1, further including a detection system arranged for providing a focus error signal and/or a radial-tracking error signal and in that it further includes a servo circuit and an actuator responsive to said focus error signal and/or said radial-tracking error signal for controlling the positions of said scanning spot with respect to the position of said information layer and/or of a track of said information layer which is to be scanned.

9. An optical scanning device as claimed in claim 8, further including an information processing unit for error correction.

10. A beam intensity modifier for use in an optical scanning device for scanning an information layer of an optical record carrier by means of a radiation beam of a predetermined wavelength, the modifier having an entrance pupil and an exit pupil, for redistributing the intensity over the cross-section of said radiation beam,
characterized in that it is arranged so that any ray of said radiation beam entering said beam intensity modifier at a distance r₁ from the central ray of said radiation beam reflects at least twice between said entrance and exit pupils such that the transverse magnification M of said intensity modifier is defined by a decreasing function of the distance r₁.
